(19) United States
(12) Patent Application Publication
(10) Pub. No.: US 2011/0254531 A1
(43) Pub. Date: Oct. 20, 2011

(54) Current Balancing Multiphase Power Converters, Controllers and Methods

(75) Inventor: Piotr Markowski, Ansonia, CT (US)

(73) Assignee: Astec International Limited, Kowloon (HK)

(21) Appl. No.: 12/763,629

(22) Filed: Apr. 20, 2010

(51) Int. Cl. G05F 1/10

(52) U.S. Cl. 323/371

(57) ABSTRACT

A method of controlling a multiphase power converter including a plurality of sub-converters is disclosed. The method includes, for each of the sub-converters, estimating a current provided by that sub-converter. The method includes selecting one of the sub-converters that is on and determined to have a greatest current as the next sub-converter to be turned off and selecting one of the sub-converters that is off and determined to have a smallest current as the next sub-converter to be turned on. Other methods, multiphase power converters and controllers for multiphase power converters are also disclosed.

### FIELD

The present disclosure relates to current balancing multiphase power converters, controllers for current balancing in multiphase power converters and methods of controlling multiphase power converters to balance currents between phases.

### BACKGROUND

This section provides background information related to the present disclosure which is not necessarily prior art.

Multiphase power converters include more than one power converter. The power converters (also known as sub-converters) of known multiphase power converters are typically operated in a discrete number of phases. Pulse width modulated (PWM) signals are typically generated for the phases by comparing a reference voltage to one or more fixed frequency and fixed magnitude saw-tooth waveforms. The timing of the turn on and/or turn off of the phases is generally dictated by the saw-tooth waveform.

Each phase of a multiphase power converter often has a low output impedance. Differences in average duty cycle among the phases can lead to significant imbalance in the current carried by each phase.

### SUMMARY

This section provides a general summary of the disclosure, and is not a comprehensive disclosure of its full scope or all of its features.

According to one aspect of this disclosure, a method of controlling a multiphase power converter including a plurality of sub-converters is disclosed. The method includes, for each of the sub-converters, estimating a current provided by said sub-converter. The method also includes selecting one of the sub-converters that is on and determined to have a greatest current as the next sub-converter to be turned off and selecting one of the sub-converters that is off and determined to have a smallest current as the next sub-converter to be turned on.

According to another aspect of the present disclosure, a method is disclosed for balancing current in a multiphase power converter including a controller and a plurality of sub-converters coupled to provide power to a load. The controller is configured to cause a variable number of the sub-converters to turn on and/or to turn off to produce a desired output from the power converter. The method includes ordering the sub-converters that are currently on in a first sequential queue having a head and a tail. The first sequential queue is ordered from head to tail by descending current. The method also includes turning off the sub-converter at the head of the first sequential queue when one of the sub-converters is to be turned off.

According to yet another aspect of the present disclosure, a method is disclosed for balancing current in a multiphase power converter including a controller and a plurality of sub-converters coupled to provide power to a load. The controller is configured to cause a variable number of the sub-converters to turn on and/or to turn off to produce a desired output from the power converter. The method includes ordering the sub-converters that are currently off in a sequential queue having a head and a tail. The sequential queue is ordered from head to tail by increasing current. The method also includes turning on the sub-converter at the head of the sequential queue when one of the sub-converters is to be turned on.

According to still another aspect of this disclosure, a method is disclosed for balancing current in a multiphase power converter including a controller and a plurality of sub-converters coupled to provide power to a load. The controller is configured to cause a variable number of the sub-converters to switch on and to switch off to produce a desired output from the power converter. The method includes totaling an on-time of each sub-converter over time. The method includes, when one of the sub-converters is to be turned off, turning off the sub-converter that has a largest total on-time and is on.

According to another aspect of this disclosure, a method is disclosed for balancing current in a multiphase power converter including a controller and a plurality of sub-converters coupled to provide power to a load. The controller is configured to cause a variable number of the sub-converters to switch on and to switch off to produce a desired output from the power converter. The method includes totaling an on-time of each sub-converter over time. The method includes, when one of the sub-converters is to be turned on, turning on the sub-converter that has a smallest on-time and is off.

Further areas of applicability will become apparent from the description provided herein. The description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flow diagram of a method of controlling a multiphase power converter according to one aspect of this disclosure.

FIG. 2 is a flow diagram of a method of controlling a multiphase power converter according to another aspect of this disclosure.

FIG. 3 is a flow diagram of a method of controlling a multiphase power converter according to still another aspect of this disclosure.

FIG. 4 is a block diagram of a multiphase power converter according to one example embodiment of the present disclosure.

FIG. 5 is a diagram of a portion of the controller for the multiphase power converter of FIG. 4.

FIG. 6 is a diagram of a portion of the phase order controller in FIG. 5.

FIG. 7 is a diagram of a current estimator for the multiphase power converter of FIG. 4.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

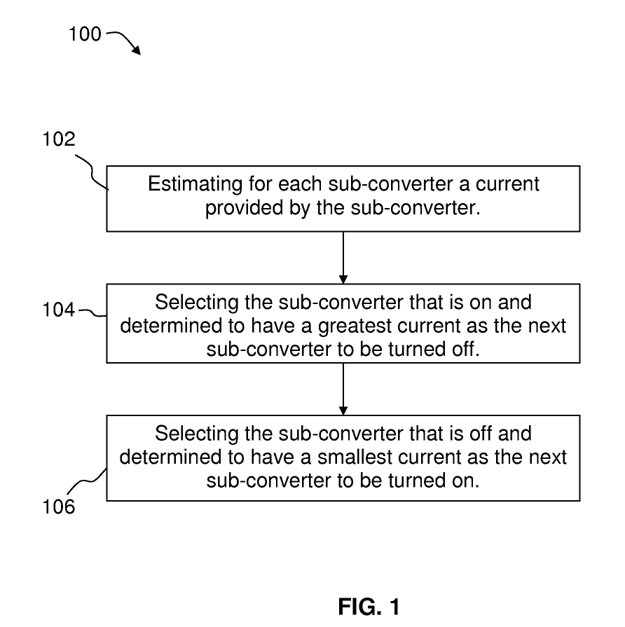

According to one aspect of the present disclosure, a method, generally indicated by the reference number 100 in FIG. 1, of controlling a multiphase power converter including a plurality of sub-converters is disclosed. The method 100 includes, at 102, estimating for each of the sub-converters a current provided by such sub-converter. At 104, the method 100 includes selecting one of the sub-converters that is on and determined to have a greatest current as the next sub-converter to be turned off. The method 100 also includes selecting one of the sub-converters that is off and determined to have a smallest current as the next sub-converter to be turned on at 106. In this manner current balancing between the sub-converters of the multiphase power converter may be achieved.

The method 100 may also allow the multiphase power converter to perform current balancing between sub-converters without any change to the flow of output power. When current balancing without changing output power is desired, the sub-converter with the greatest current may be turned off at the same time as the sub-converter with the lowest current is turned on. In this way, the voltage transfer function of the power converter can remain unchanged while current balancing is performed.

Estimating the current provided by each sub-converter may be performed directly or indirectly. For example, the current provided by a sub-converter may be monitored or measured. The actual current may be measured using any suitable techniques, including, for example, by using a current transformer, a sense resistor, etc. The current may additionally, or alternatively, be estimated indirectly. The current may be estimated indirectly by calculation, look-up table, by monitoring something related to (e.g., proportional to) current, etc.

The current provided by each sub-converter relative to the other sub-converters may be determined by comparing the current (however acquired) using one or more analog and/or digital circuit(s). For example, a series of analog comparators may be used to compare the current for each sub-converter, a microcontroller may perform the comparison digitally, etc.

The method 100 may further include estimating the current for each of the sub-converters based on a net length of time said sub-converter has been on and/or off during a defined interval. The net length of time a sub-converter has been on and/or off during a defined interval may be used as an estimate of the current provided by that sub-converter during the defined interval.

The defined interval may be a fixed interval of time and/or a variable interval of time. For example, the defined interval may be a fixed (and specific) time interval, may be a fixed time interval relative to some triggering event (such as turn on of a specific sub-converter), may be a fixed amount of time relative to the present moment (e.g., the last one second), may be based on the number of switching cycles of the sub-converters (which may be a fixed defined time interval or a variable defined time interval), etc. The defined interval may vary based on any suitable criterion or criteria. For example, the defined time interval may be varied based on the total current provided by the multiphase power converter (such as, shortening the time interval if more current is being provided by the multiphase power converter), the number of switching cycles of the sub-converters, etc.

The method 100 may include ordering the sub-converters that are currently on in a first queue (also referred to herein as an on-queue) from largest to smallest estimated current and ordering the sub-converters that are currently off in a second queue (also referred to herein as an off-queue) from smallest to largest estimated current. The on-queue and the off-queue may be separate queues or may be parts of the same queue. If the on-queue and the off queue are part of the same queue, the on-queue and off-queue may be separated/offset from each other within the queue.

The method 100 may also include selecting one of the sub-converters to be turned off by sequentially selecting a sub-converter from the on-queue and selecting one of the sub-converters to be turned on by sequentially selecting a sub-converter from the off-queue.

By ordering the sub-converters in the on-queue and off-queue and selecting the sub-converters to be turned off and/or on sequentially from the on-queue and off-queue, the multiphase power converter need not estimate the current provided by each sub-converter and/or determine which converter has the smallest/greatest current before every turn-on/turn-off event. As a result, the multiphase power converter may turn one or more sub-converters on and/or off without waiting for a current estimation and/or determination. The multiphase power converter need only select the next sub-converter in sequence from the appropriate queue as the next sub-converter to turn on/off. As a result, the multiphase power converter can turn sub-converters on and/or off at a higher frequency than if a current estimation and/or determination were required before every turn on and/or off event.

Estimating the current, ordering the sub-converters that are currently on in the on-queue and/or ordering the sub-converters that are currently off in the off-queue may be repeated periodically. Further, the multiphase power converter may turn one or more sub-converters on and/or off more frequently than the estimating and ordering are performed.

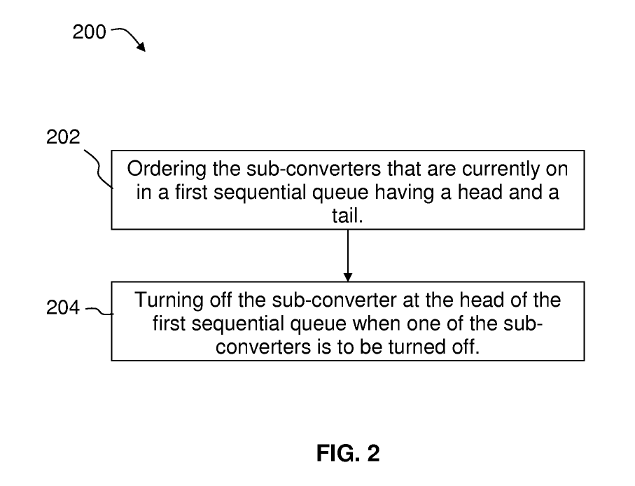

With reference to FIG. 2, according to another aspect of the present disclosure, a method 200 is disclosed for balancing current in a multiphase power converter including a controller and a plurality of sub-converters coupled to provide power to a load. The controller is configured to cause a variable number of the sub-converters to turn on and/or to turn off to produce a desired output from the power converter. The method 200 includes, at 202, ordering the sub-converters that are currently on in a first sequential queue (also referred to herein as an on-queue) having a head and a tail. The on-queue is ordered from head to tail by descending current. At 204, the method also includes turning off the sub-converter at the head of the on-queue when one of the sub-converters is to be turned off.

By ordering the sub-converters in the on-queue by descending current and selecting the sub-converter at the head of the on-queue to be turned off, the multiphase power converter can readily turn off the sub-converter that has the greatest current. The multiphase power converter need not estimate, determine, calculate, etc. the current provided by each sub-converter before every turn-off event. As a result, the multiphase power converter may turn off one or more sub-converters without being required to wait for an estimation, determination, etc. The multiphase power converter need only select the next sub-converter in sequence from the first sequential queue as the next sub-converter to turn off. As a result, the multiphase power converter can turn off sub-converters at a high frequency.

Additionally, or alternatively, the multiphase power converter may also turn off multiple sub-converters simultaneously. This is accomplished by turning off, at the same time, multiple sub-converters selected sequentially beginning at the head of the on-queue. For example, when/if the multiphase power converter needs to turn off three sub-converters, the first, second and third sub-converters in the on-queue (counting from the head of the queue) are simultaneously turned off.

The method 200 may also include reordering the on-queue periodically. Over time, the order of the on-queue may, or may not, become inaccurate, incomplete, stale, etc. as sub-converters in the on-queue are turned off and other sub-converters are turned on. Periodically reordering the on-queue helps maintain the sequential order by descending current for the sub-converters that are on. The reordering may occur less frequently than the frequency at which the multiphase power converter turns sub-converters off.

The method 200 may include ordering the sub-converters that are currently off in a second sequential queue (also referred to herein as an off-queue) having a head and a tail, the second sequential queue ordered from head to tail by increasing current, and turning on the sub-converter at the head of the second sequential queue when one of the sub-converters is to be turned on. The method 200 may include reordering the second sequential queue periodically.

By ordering the sub-converters in the off-queue by increasing current and selecting the sub-converter at the head of the off-queue to be turned on, the multiphase power converter can readily turn on the sub-converter that has the smallest current. The multiphase power converter need not estimate, determine, calculate, etc. the current provided by each sub-converter before every turn-off event. As a result, the multiphase power converter may turn on one or more sub-converters without being required to wait for an estimation, determination, etc. The multiphase power converter need only select the next sub-converter in sequence from the off-queue as the next sub-converter to turn on. As a result, the multiphase power converter can turn on sub-converters at a high frequency.

Additionally, or alternatively, the multiphase power converter may also turn on multiple sub-converters simultaneously. This is accomplished by turning on, at the same time, multiple sub-converters selected sequentially beginning at the head of the off-queue. For example, when/if the multiphase power converter needs to turn on three sub-converters, the first, second and third sub-converters in the off-queue (counting from the head of the queue) are simultaneously turned on.

The method 200 may also allow the multiphase power converter to perform current balancing between sub-converters without any change to the flow of output power. When current balancing without changing output power is desired, the sub-converter at the head of the on-queue may be turned off at the same time as the sub-converter at the head of the off-queue is turned on. In this way, the voltage transfer function of the power converter can remain unchanged while current balancing is performed.

The method 200 may include estimating, for each sub-converter, the current based on an integral of the on-time of each sub-converter during a particular interval.

The method 200 may include estimating, for each sub-converter, the current based on a net cumulative on time of each sub-converter during a particular interval. As discussed above with respect to the method 100, the on-time of a sub-converter over a given time period may be proportional to the current provided by the sub-converter.

The on-time of each sub-converter may be determined directly or indirectly. For example, the on-time for each sub-converter may be directly determined by simply being totaled and stored by a controller for the multiphase power converter (e.g., the controller that sends the signals to each sub-converter to turn on/off).

The on-time for each sub-converter may be determined indirectly (or estimated) by other digital or analog circuits. For example, the multiphase power converter may include a plurality of counters and each counter may be associated with a different one of the sub-converters. The method 200 may include periodically incrementing a count value of the counters associated with the sub-converters in the on-queue. Accordingly, when a sub-converter is on, its associated counter is periodically incremented. When a sub-converter is off, its associated counter is not incremented. Thus, the sub-converter that is on and has the associated counter with the highest count is the sub-converter that has the greatest net on-time. Accordingly, the method 200 may include estimating, for each sub-converter, the current based on the count value of the counter associated with the sub-converter.

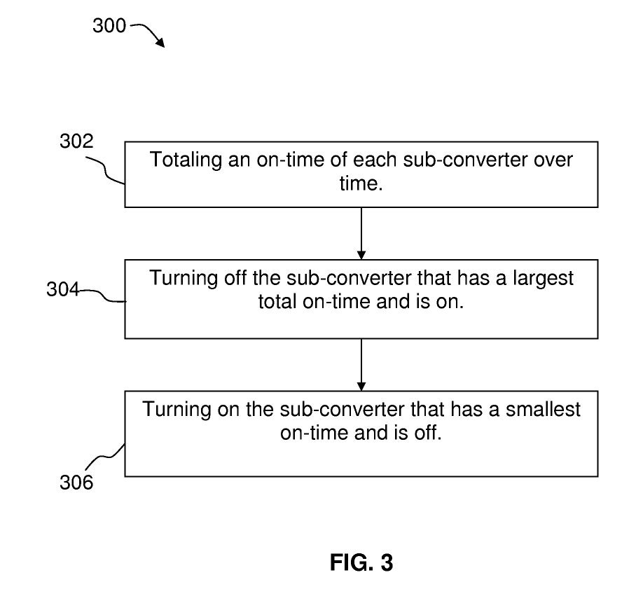

FIG. 3 illustrates a method 300 of balancing current in a multiphase power converter according to another aspect of this disclosure. The multiphase power converter includes a controller and a plurality of sub-converters coupled to provide power to a load. The controller is configured to cause a variable number of the sub-converters to switch on and to switch off to produce a desired output from the power converter. The method 300 includes, at 302, totaling an on-time of each sub-converter over time. At 304, the method 300 includes when one of the sub-converters is to be turned off, turning off the sub-converter that has a largest total on-time and is on. When one of the sub-converters is to be turned on, at 306 the method 300 includes turning on the sub-converter that has a smallest on-time and is off.

The method 300 may include sequentially ordering the sub-converters that are on in an on-queue by descending total on-time, and sequentially ordering the sub-converters that are off in an off-queue by ascending total on-time.

The method 300 may also include periodically reordering the on-queue, and periodically reordering the off-queue. Turning on and/or turning off the sub-converters may occur at a higher frequency than the frequency at which the on-queue and the off-queue are reordered.

In one example embodiment of the method 300, the sub-converter to be turned off is selected by selecting the first sub-converter in the on-queue and the sub-converter to be turned on is selected by selecting the first sub-controller in the off-queue. When only current balancing is desired (i.e., no change in output power is desired), one or more sub-converters in the on-queue may be turned off at the same time as the same number of sub-converters in the off-queue are turned on.

The aspects described above, and multiphase power converters configured to operate according to one or more of the aspects described above, may be used in any suitable multiphase power converter application. For example, they may be used with a multiphase power converter for a radio frequency (RF) amplifier, a multiphase power converter for a system with rapidly changing current demands, etc. The aspects described above may be performed by one or more controllers. Each controller may be analog and/or digital, may be an integrated circuit or a group of components and/or integrated circuits, may be a microcontroller, microprocessor, etc., may be a combination of one or more of the preceding, etc.

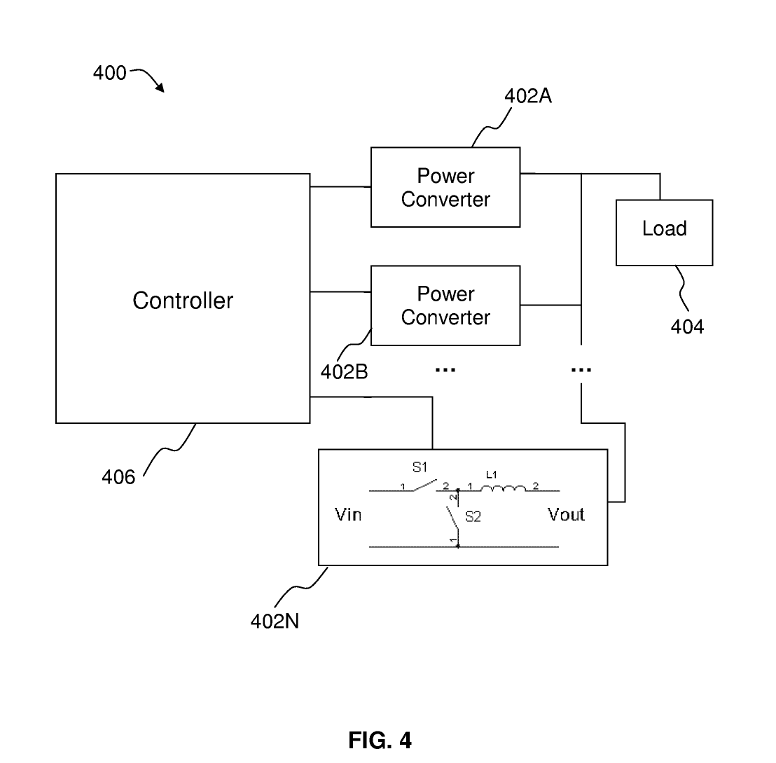

One example embodiment of a multiphase power converter 400 implementing the aspects described above will now be described with reference to FIGS. 4 to 7. It should be understood, however, that the teachings of this disclosure are not limited to the particular examples shown, and that one or more of the aspects described above can be implemented, individually or in various combinations, in a variety of other multiphase power converters without departing from the scope of this disclosure.

As shown in FIG. 4, the power converter 400 includes a plurality of sub-converters 402A through 402N (generally, the sub-converters 402). Although only three sub-converters 402 are illustrated, any appropriate number of sub-converters 402 may be employed. The “N” in reference number 402 N simply indicates that it is the Nth sub-converter of N sub-converters, where N is a positive integer.

Sub-converter 402N illustrates one example sub-converter as a synchronous buck converter. However, the sub-converters 402 may be any suitable sub-converter topology including, for example, a buck converter using a diode in place of switch S2.

In the example of FIG. 4, the sub-converters 402 are coupled in parallel to provide an output to a load 404. Each of the sub-converters 402 includes at least one power switch, such as switch 51 in sub-converter 402N. In this embodiment, a controller 406 estimates for each of the sub-converters 402 a total current delivered in a defined interval. The controller 406 is configured to select one of the sub-converters 402 that is on and determined to have the greatest current as the next sub-converter 402 to be turned off. Similarly, the controller 406 is configured to select one of the sub-converters 402 that is off and determined to have the smallest current as the next sub-converter 402 to be turned on.

The sub-converters 402 are ordered in two queues. The sub-converters 402 that are currently on (if any) are assigned to an on-queue in sequential order from greatest current to least current (from head to tail in the queue). Similarly, the sub-converters 402 that are currently off (if any) are assigned to an off-queue in sequential order from least current to greatest current (from head to tail in the queue). When a sub-converter is to be turned off, the controller 406 turns off the sub-converter 402 at the head of the on-queue. When a sub-converter 402 is to be turned on, the controller 406 turns on the converter at the head of the off-queue. Accordingly, selection of the sub-converter 402 with the greatest current for turn-off and selection of the sub-converter with the least current for turn-on is accomplished automatically by turning on/off the sub-converter 402 at the head of the appropriate queue.

The on-queue and off-queue may be separate queues or may be a single queue with or without some separation between the sub-converters 402 that are on and the sub-converters 402 that are off. In a single queue embodiment, the on-queue and off-queue may be considered first and second groups within the single queue. For example, the on-queue may be a first group including positions one to fifteen of the single queue and the off-queue queue may be a second group including positions sixteen to thirty in the single queue. All positions in the on-queue and/or the off-queue are not necessarily occupied by a sub-converter. For example, there may be fifteen positions in the on-queue and fifteen positions in the off-queue, but only ten sub-converters. In such an example, no matter how many sub-converters are on and/or off, there will always be unoccupied positions in the queues.

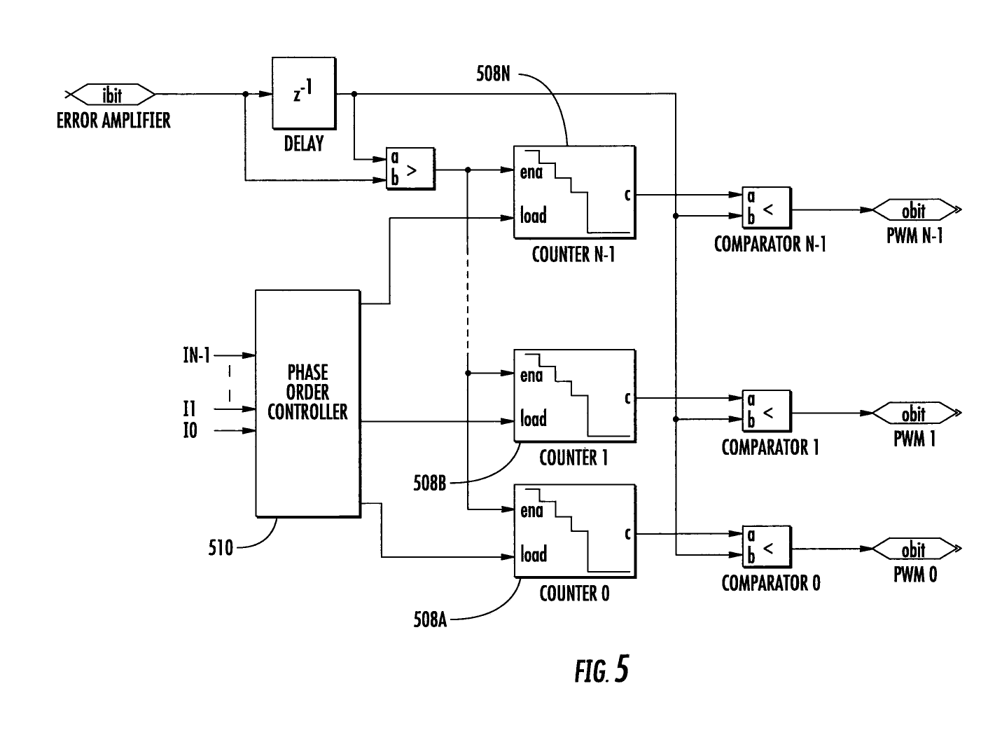

The on-queue and off-queue may be implemented in any suitable way. FIG. 5 illustrates part of the controller 406 for one example implementation of the on-queue and the off-queue. The controller 406 includes a plurality of counters 508A through 508N (generally, the counters 508). Each of the counters 508 has a controllable state, i.e. a count. The count is typically represented as an integer value. Each counter may be incremented to change (or increment) its count up or down by a certain value (typically one).

Each of the counters 508 is associated with a different one of the sub-converters 402. For example, counter 508A may be associated with converter 402A, counter 508B may be associated with converter 402B and counter 508N may be associated with converter 402N.

The counters 508 form a virtual queue. The count of each counter 508 indicates the position of its associated sub-converter 402 in the queue. The virtual queue formed by the counters 508 can be the on-queue, the off-queue or a single queue including both the on-queue and the off-queue. The position of the sub-converters 402 in the queue determines the order in which the sub-converters 402 will be turned on and/or off. The order of the queue may be set by a phase order controller 510. The phase order controller 510 is operable to output a load value to each of the counters 508 to force each counter to a certain count and thereby to force each sub-converter 402 to a certain position in the queue. This can be beneficial at times, such as at startup of the multiphase power converter 400, when it may be desirable to arbitrarily order the sub-converters 402 (because, for example, the sub-converters 402 are carrying no current, the current is unknown, etc.).

In this example embodiment, an output voltage of the multiphase power converter 400 is regulated by changing the number of sub-converters 402 that are on at any given time. Increasing the flow of the power from the power converter 400 is achieved by increasing the number of sub-converters 402 that are on and reduction in the flow of the power is achieved by reducing the number of sub-converters 402 that are on. Each sub-converter 402 that turns off goes to the end of the off-queue of sub-converters 402. When the controller 406 increases the number of sub-converters 402 that are on, the sub-converter 402 at the head of the off-queue is turned on and placed at the tail of the on-queue and the other sub-converters 402 in the off-queue are advanced toward the head of the off-queue. The on-queue operates similarly for the sub-converters 402 that are on. When a sub-converter 402 is turned on, it is placed at the end/tail of the on-queue. When a sub-converter is turned off, it leaves the on-queue (to be placed in the off-queue) and the remaining sub-converters 402 advance toward the head of the on-queue.

The order of the sub-converters 402 in the on-queue and off-queue may be periodically reevaluated and corrected as needed. This may occur after every switching transition, every clock cycle, after a fixed period of time, etc. For example, in one embodiment the queues are reordered just before any change in the number of sub-converters that are turned on. In this way current balancing is performed simultaneously with the regulation of the flow of the power, thus limiting any additional power switching transitions. When no change of the number of active sub-converters is needed for an extended period of time, simultaneous turn-off and turn-on of sub-converters from both queues may be commanded along with appropriate queue reordering. This can be triggered after predetermined time with no change in the number of sub-converters that are on, or by exceeding a specified limit of the current, or by exceeding a specified on-time imbalance, etc. In another example, the queues may be reordered less frequently than before every change in the number of sub-converters that are on. For example, the queues may be reordered once every few times the number of turned on sub-converters changes. In such an embodiment, accuracy of the current balancing will decrease, but may still be acceptable for some applications.

Instead of having fixed order in the on-queue and/or off-queue, the order of the sub-converters 402 in the queues can be modified to provide current balancing between the sub-converters 402. Such current balancing may be achieved by changing the order of sub-converters 402 in the on-queue and/or the off-queue depending on each sub-converter's current relative to the currents in the other sub-converters 402. For example, a sub-converter 402 that has relatively high current will be advanced to the beginning (or head) of the on-queue if it is currently on, or will be pushed toward the end (or tail) of the off-queue, if it is currently off. Similarly, a sub-converter 402 with relatively low current will be pushed toward the end/tail of the on-queue (if it is currently on) or advanced to the beginning/head of the second queue (if it is currently off). This reordering of the sub-converters 402 extends the duration of the on state of sub-converters 402 experiencing low current and reduces the duration of the on state of sub-converters 402 experiencing high current. Accordingly, over a limited number of switching cycles (possibly even over a single cycle), the current provided by the sub-converters 402 may be balanced.

A change in the position of one of the sub-converters 402 in either queue is automatically compensated by the opposite change of the position of other sub-converters 402 in that queue. Advancement of a particular sub-converter 402 in either queue is automatically accompanied by the delay of those sub-converters 402 in such queue ahead of which the advanced sub-converter 402 was placed. For the on-queue, for example, the advanced sub-converter 402 will turn off sooner (e.g., it will be the next sub-converter 402 that is turned off) and the sub-converters 402 ahead of which the advanced sub-converter was placed will turn off later (e.g., a switching cycle after the advanced sub-converter).

The sub-converters 402 in the on-queue and the off-queue may reordered (or repositioned) individually or as a group. In one example embodiment, the controller 406 may simply determine the sub-converter 402 with the highest current and advance it to the head of the on-queue or the tail of the off-queue, as appropriate. In another embodiment, the controller 406 may compare the current in all of the sub-converters 402 and reorder the entire on-queue and/or off-queue as appropriate to maintain the order from greatest to least current (in the on-queue) and/or from least to greatest current (in the off-queue).

In this way current balancing between sub-converter 402 can be achieved. Each sub-converter 402 is restored to approximate current balance with the other sub-converters 402 in as little as one switching cycle. The sub-converter 402 that has high current will experience “accelerated” turn off and then it may be “trapped” in the off state (i.e. it will experience series of delays) until its current decays to such low level that it has the lowest current of all sub-converters 402 in off-queue. After reaching that lowest level (relative to the other sub-converters 402), it will be allowed to turn-on and move to the on-queue. Similarly, the sub-converter 402 that has the lowest current will be “accelerated” towards turn-on (by being moved to the head of the off-queue) and then kept in this on state (i.e., it will experience series of delays) until there is no other sub-converter 402 with the current higher than this sub-converter 402. Only after that will it be allowed to turn off and move to the off-queue.

This varied ordering of the sub-converters 402 via the on-queue and off-queue does not otherwise affect the control of the multiphase power converter 400. The number of sub-converters 402 in an on state and the number of sub-converters 402 that are in an off state will be unaffected and equal to that commanded by the controller 406. It is simply the order in which the sub-converters 402 are turned on/off that is varied. As a result, current balancing results in little or no impact on the flow of the power from the multiphase power converter 400.

Generally no additional switching transitions (i.e. turning on/off a switch in one of the sub-converters 402) are created by the process of current balancing described herein. Neither the measurement/estimation of the current of the sub-converters 402, nor the ordering/re-ordering of the sub-converters 402 in the queues causes any of the sub-converters 402 to be turned off and/or on. The controller 406 creates switching transitions as needed for output power regulation without respect to the measured/estimated current for each sub-converter 402. The use of the ordered on-queue and off-queue presents the controller 406 with the sub-converters 402 ordered such that the next sub-converter that the controller 406 turns on/off will provide current balancing benefits for the multiphase power converter 400. Accordingly, this current balancing results in the same number of switching transitions, but with a variable ordering, providing an average on-time approximately equally distributed between various sub-converters 402 (which leads to approximately equal current distribution among the sub-converters 402).

In certain, particularly abnormal, situations, the controller 406 may use the measured/estimated current to create additional switching transitions. In particular, if the current in a particular sub-converter 402 reaches a threshold (i.e. an over current limit), the controller may turn off the excessively high current sub-converter 402 directly and move it to the off-queue without moving its order in the on-queue and waiting for the next desired turn-off time. In such a situation, the sub-converter 402 at the head of the off-queue may be simultaneously turned on (and moved to the on-queue) to avoid altering the output of the multiphase power converter 400.

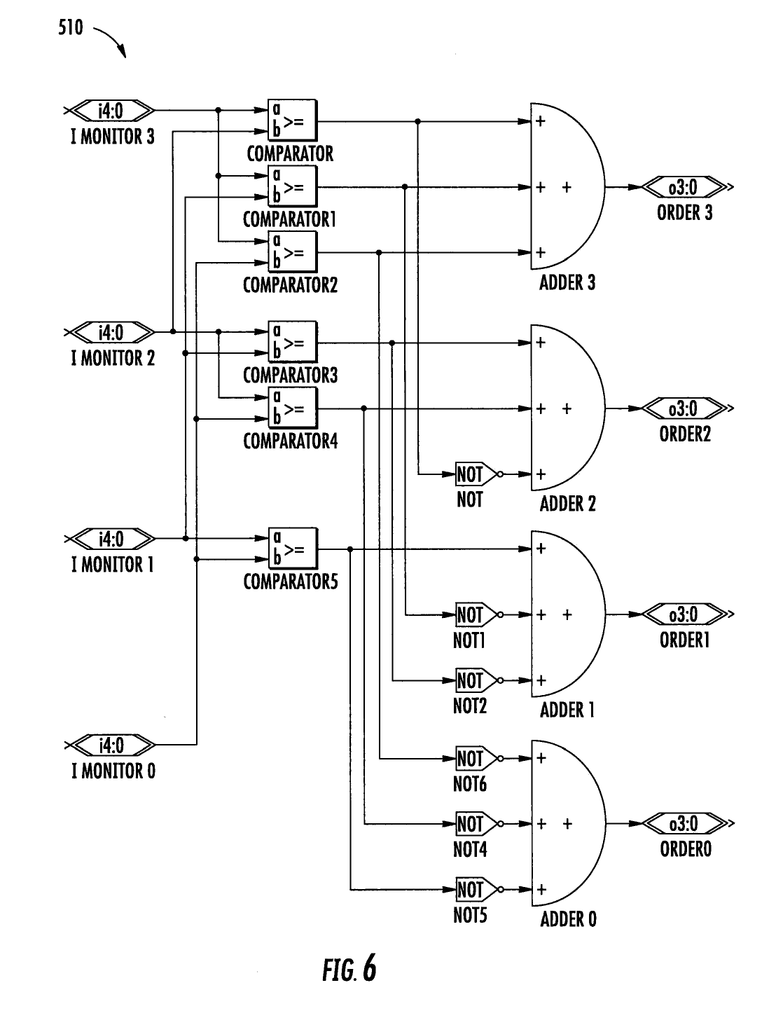

Ordering the sub-converters 402 in the on-queue and off-queue can be done in many ways. FIG. 6 illustrates one suitable circuit for the phase order controller 510. In this example embodiment, ordering the sub-converters 402 is based on direct current level comparison of all sub-converters 402 regardless of whether the particular sub-converter is in the on-queue or the off-queue. Comparison can be performed in an analog or a digital domain. The total number of comparisons needed for the multiphase power converter 400 is equal to ½ n(n+1), where n is the number of sub-converters 402.

Because all sub-converters 402 are compared without regard to whether they are on or off, the results of all comparisons are modified in order to avoid transfer of sub-converters 402 between the on-queue and the off-queue. This is achieved in this embodiment by forcing all comparison results between sub-converters 402 in opposite states (ON and OFF) to an arbitrary result regardless of the actual current levels. For, example, comparisons between sub-converters 402 in the on-queue and off-queue may be forced to always indicate that the sub-converter 402 in the off-queue has a higher current. A fixed large offset may be added to current signals of all off-queue sub-converters 402 to achieve this result. The number should be larger than the maximum actual current signal. In this way all comparisons within the on-queue or the off-queue (intra-queue comparisons) will be correct, while comparisons between members of on-queue and the second queue (inter-queue comparisons) will be fixed so as to maintain the distinction between the on-queue and the off-queue.

Results for all comparisons for each sub-converter 402 are added, creating a number corresponding to the order of the sub-converters 402. This number is then used to order the sub-converters 402 as described above.

The comparisons described above may be performed by analog or digital components, by discrete component or integrated circuits, may be realized by appropriate software/instructions in a microprocessor, etc.

The current balancing described herein can be realized with very high bandwidth in modern digital circuits. The simplicity of digital signal processing allows for implementation which can be executed in just few clock cycles. The amount of digital resources necessary to perform all comparisons is low, especially considering that high accuracy may not be needed and three to five bit comparators may be sufficient.

The current in each sub-converter may be a measured current (such as measured using a hall sensor, sense resistor, current transformer, etc.) or may be estimated (such as by a lookup table, based on some other characteristic/value of the sub-converter, etc.).

In this particular embodiment, the actual current of each sub-converter 402 is replaced with a signal derived from observation of the on-time of the sub-converter 402. The AC current of a power inductor (e.g., L1 in 402N) in a sub-converter 402 is proportional to the integral of the volt-seconds imposed on the inductor. Because the inductors of all of the sub-converters 402 are connected to the same output voltage and are switched between the same input voltages (Vin and ground/return), their AC currents and associated current imbalance depend only on the difference/imbalance between their respective on-times. Information about the on-time of all sub-converters 402 is sufficient to regulate the rapidly changing component of the sub-converter 402 current imbalance.

Accordingly, the input signals to the phase order controller 510 can be AC current estimate signals. Each AC current estimate signal is proportional to the integral of the ON time for a particular sub-converter 402. This signal can be obtained in an analog or digital domain, inside or outside the controller 406.

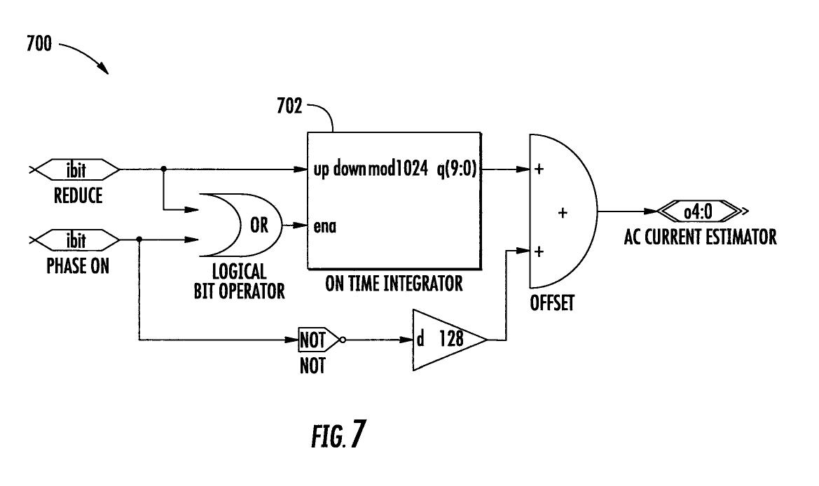

One suitable estimator 700 for estimating the current of the sub-converters 402 is illustrated in FIG. 7. One estimator 700 is used for each sub-converter 402. In this example embodiment, the current estimate is determined within the controller. Each PWM output of the controller 406 (which provides the turn-on signal to one of the sub-converters 402) has its own counter 702. Accordingly, each counter 702 is associated with one of the sub-converters 402. Each counter 702 is active (i.e., advances at constant rate) while the sub-converter with which it is associated is turned on. Each counter 702 increments by a value of one every clock cycle. Conversely, each counter 702 is inactive (i.e., stopped, doesn't advance) when its associated sub-converter is off. Furthermore, the output of each counter 702 associated with a sub-converter that is off is increased by 128. This creates an output shift to place all sub-converters that are off at the top of the queue and creates separation between the sub-converters that are on and the sub-converters that are off (creating two virtual queues out of one actual queue). This separation helps avoid the on-queue and off-queue overlapping, which could cause erroneous results, additional switching transitions (as a change in a sub-converter's position in the queue unintentionally moved it from, for example, the on-queue to the off-queue), etc. The output of the counter 702 is used as the current estimate for the associated sub-converter 402 in the manner discussed above. Counters 702 can be periodically moved in backward direction (signal REDUCE in FIG. 7) or simultaneously reset to prevent overflow (e.g., to prevent the counter from reaching its maximum count and/or resetting itself to a count of zero) that could lead to erroneous comparison results. The illustrated estimator 700 may be separate components, may be an integrated circuit, may be implemented in a microcontroller, may be implemented by software, etc.

Power converters incorporating one or more of the aspects described above may be especially useful in, for example, applications in which output requirements change very rapidly. In particular, such power converters may be useful in applications in which the power converter output may need to be changed at frequencies much higher than the typical switching frequencies of the sub-converters that make up the power converter.

Controllers for multiphase power converters according to this disclosure may be analog controllers and/or digital controllers. The controllers can include one or more discrete components, one or more integrated circuits, microcontrollers, digital signal processors, etc. Further, the methods and embodiments disclosed herein may be implemented via hardware and/or software. For example, the counters discussed above may be operations performed by software in a microprocessor.

The sub-converters used in multiphase power converters according to this disclosure above may be any suitable power converter. For example, the sub-converters may be isolated converters or non-isolated converters. The converters may be buck converters, forward converters, converters derived from buck converters, converters derived from forward converters, etc.

In one example embodiment, a multiphase power converter including one or more aspects described above is designed for delivering power to an RF power amplifier. The example converter includes sixteen sub-converters and a digital controller. In this example embodiment, the switching frequency is variable and may be different in each sub-converter as dictated by rapidly varying power requirements driven by random contents of the radio transmission. The average switching frequency typically is in the range of 1 to 5 MHz for each sub-converter. The queue is reordered before every switching transition or whenever no switching transition has been commanded for 15 ns. The maximum average output power is 150 Watts and momentary peak power is 500 Watts. The output voltage is regulated from 0 to 16V.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A method of controlling a multiphase power converter including a plurality of sub-converters, the method comprising:
estimating for each of the sub-converters a current provided by said sub-converter;
selecting one of the sub-converters that is on and determined to have a greatest current as the next sub-converter to be turned off; and
selecting one of the sub-converters that is off and determined to have a smallest current as the next sub-converter to be turned on.

2. The method of claim 1 wherein estimating the current for each of the sub-converters is based on a net length of time said sub-converter has been on and/or off during a defined interval.

3. The method of claim 1 further comprising ordering the sub-converters that are currently on in a first queue from largest to smallest estimated current and ordering the sub-converters that are currently off in a second queue from smallest to largest estimated current.

4. The method of claim 3 wherein selecting one of the sub-converters to be turned off includes sequentially selecting a sub-converter from the first queue and selecting one of the sub-converters to be turned on includes sequentially selecting a sub-converter from the second queue.

5. The method of claim 3 wherein estimating the current, ordering the sub-converters that are currently on in the first queue and ordering the sub-converters that are currently off in the second queue are repeated periodically.

6. The method of claim 1 wherein estimating the current in each of the sub-converters is repeated periodically.

7-8. (canceled)

9. A method of balancing current in a multiphase power converter including a controller and a plurality of sub-converters coupled to provide power to a load, the controller configured to cause a variable number of the sub-converters to turn on and/or to turn off to produce a desired output from the power converter, the method comprising:
ordering the sub-converters that are currently on in a first sequential queue having a head and a tail, the first sequential queue ordered from head to tail by descending current; and
turning off the sub-converter at the head of the first sequential queue when one of the sub-converters is to be turned off.

10. The method of claim 9 further comprising reordering the first sequential queue periodically.

11. The method of claim 10 further comprising ordering the sub-converters that are currently off in a second sequential queue having a head and a tail, the second sequential queue ordered from head to tail by increasing current, and turning on the sub-converter at the head of the second sequential queue when one of the sub-converters is to be turned on.

12. The method of claim 11 further comprising reordering the second sequential queue periodically.

13. The method of claim 12 further comprising estimating, for each sub-converter, the current based on a net cumulative on time of each sub-converter during a particular interval.

14. The method of claim 12 further comprising estimating, for each sub-converter, the current during the particular interval based on an integral of on-time of the sub-converter.

15. The method of claim 12 wherein the multiphase power converter includes a plurality of counters, each counter associated with a different one of the sub-converters, the method further comprising periodically incrementing a count value of the counters associated with the sub-converters in the first sequential queue.

16. The method of claim 15 further comprising estimating, for each sub-converter, the current based on the count value of the counter associated with the sub-converter.

17. A controller for a multiphase power converter, the controller configured to perform the method of claim 9.

18. A multiphase power converter comprising the controller of claim 17 and a plurality of sub-converters coupled to provide power to a load.

19. A method of balancing current in a multiphase power converter including a controller and a plurality of sub-converters coupled to provide power to a load, the controller configured to cause a variable number of the sub-converters to switch on and to switch off to produce a desired output from the power converter, the method comprising:
totaling an on-time of each sub-converter over time;
when one of the sub-converters is to be turned off, turning off the sub-converter that has a largest total on-time and is on.

20. The method of claim 19 further comprising ordering the sub-converters that are on in a sequential queue by descending total on-time.

21. The method of claim 20 further comprising periodically reordering the sequential queue.

22. The method of claim 21 wherein turning on the sub-converters occurs at a higher frequency than reordering the sequential queue.

23. The method of claim 20 wherein the sub-converter to be turned off is selected by turning off the first sub-converter in the sequential queue.

24. A controller for a multiphase power converter, the controller configured to perform the method of claim 19.

25. A multiphase power converter comprising the controller of claim 24 and a plurality of sub-converters coupled to provide power to a load.

26. The method of claim 19 further comprising, when one of the sub-converters is to be turned on, turning on the sub-converter that has a smallest on-time and is off.

27. The method of claim 26 further comprising ordering the sub-converters that are on in a first sequential queue by descending total on-time, and ordering the sub-converters that are off in a second sequential queue by increasing total on-time.

28. The method of claim 27 further comprising periodically reordering the first sequential queue, and periodically reordering the second sequential queue.

29. The method of claim 28 wherein turning on and/or turning off the sub-converters occurs at a higher frequency than reordering the first and second sequential queues.

30. The method of claim 27 wherein the sub-converter to be turned off is selected by turning off the first sub-converter in the first sequential queue and the sub-converter to be turned on is selected by turning on the first sub-controller in the second sequential queue.

31. A controller for a multiphase power converter, the controller configured to perform the method of claim 26.

32. A multiphase power converter comprising the controller of claim 31 and a plurality of sub-converters coupled to provide power to a load.

33-42. (canceled)
